(19) United States
(12) Patent Application Publication
(10) Pub. No.: US 2012/0321743 A1
(43) Pub. Date: Dec. 20, 2012

(54) GUM BASES HAVING REDUCED ADHESION TO ENVIRONMENTAL SURFACES

(76) Inventors: David R. Phillips, Crest Hill, IL (US); Leslie D. Morgret, Chicago, IL (US); Michael Catizone, Plainfield, IL (US)

(21) Appl. No.: 13/521,186

(22) PCT Filed: Feb. 25, 2011
(86) PCT No.: PCT/US11/26204

§ 371 Date: Sep. 4, 2012

Related U.S. Application Data
(60) Provisional application No. 61/308,514, filed on Feb. 26, 2010.
(60) Provisional application No. 61/325,542, filed on Apr. 19, 2010.

(51) Int. Cl. A23G 4/08

(52) U.S. Cl. 426/4; 426/6

(57) ABSTRACT

A gum base which, when formulated into a chewing gum, provides a gum cud removable from environmental surfaces, contains 40-95 wt. % polyethylene having a weight average molecular weight of 2000 to 23000 daltons.

### CROSS-REFERENCE TO RELATED APPLICATIONS

This application claims benefit to U.S. Provisional Application No. 61/308,514 filed Feb. 26, 2010 and U.S. Provisional Application No. 61/325,542 filed Apr. 19, 2010, incorporated by reference herein .

### BACKGROUND OF THE INVENTION

The present invention relates to gum bases and chewing gums. More specifically, this invention relates to improved chewing gum bases and chewing gums with enhanced removability.

The precursor's to today's chewing gum compositions were developed in the nineteenth century. Today's version is enjoyed daily by millions of people worldwide.

When chewing gum is chewed, water soluble components, such as sugars and sugar alcohols are released with varying degrees of speed within the mouth, leaving a water insoluble chewing gum cud. After some amount of time, typically after the majority of the water soluble components have been released therefrom, the cud may be disposed of by the user. Although typically not problematic when disposed of properly, e.g., when wrapped in a substrate such as the original wrapper, or disposed of in a proper receptacle, improper disposal of chewing gum cuds can result in adhesion of cuds to environmental surfaces.

Conventional gum bases used in commercial chewing gum products behave as viscous liquids which provide flow and elasticity characteristics which contribute to their desirable chewing properties. However, when the chewed cuds formed from such conventional chewing gum products become undesirably adhered to rough environmental surfaces such as concrete, over time, the elastomeric components flow into the pores, cracks and crevices of such surfaces. The problem is exacerbated when the adhered cud has been subjected to pressure (for example through foot traffic) and temperature cycling. If removed promptly, conventional gum base cuds may be removable with varying degrees of difficulty. If not removed promptly, adhered gum cuds of conventional gum base formulations, and even some formulas claiming to have reduced adhesion, can be extremely difficult or impossible to remove completely from environmental surfaces.

Thus there is a need for a gum base and chewing gum containing the same that exhibits the desired characteristics for consumer acceptability, while also producing a cud which is easily removable from environmental surfaces onto which it may have become adhered.

### SUMMARY OF THE INVENTION

A gum base which, when formulated into a chewing gum, provides a gum cud removable from environmental surfaces, contains 40-95 wt. % polyethylene having a weight average molecular weight of 2000 to 23000 daltons.

### DESCRIPTION OF THE INVENTION

The present invention is directed to gum bases and chewing gums containing such gum bases in which the gum base contains 45 wt. % to 95 wt. % of a low molecular weight polyethylene. In some embodiment, the gum base will comprise 50 to 75 wt. % or 55 to 70 wt. % polyethylene. In some embodiments, the gum base contains 3 to 30 wt. % of at least one elastomer. In some embodiments, the gum base will comprise 5 to 28 wt. % of at least one elastomer or even at 8 to 25 wt. % of at least one elastomer. In some embodiments, the gum base will comprise 0 to 30 wt. % or 0 to 20 wt. % or 0 to 10 wt. % of a plastic resin such as polyvinyl acetate. For purposes of this invention, the term ‘gum base’ will be used to refer to all water insoluble components of a chewing gum (other than flavoring agents) which are present in a finished chewing gum, regardless of whether they are added as one or more separate, premixed compositions or added individually to a chewing gum mixture.

Many environmental surfaces are rough or porous at a macroscopic or microscopic level. Such surfaces provide cracks, crevices and pores which increase adhesion of discarded gum cuds. Once such adhesion has occurred, it may be extremely difficult or impossible to completely remove the cud.

It has now been found that by formulating a gum base to contain high levels of polyethylene as described above, it is possible to prepare chewing gums which, when chewed to a cud and discarded, exhibit reduced adhesion to environmental surfaces such as concrete, carpet, fabrics and hair compared to chewing gums which incorporate conventionally formulated gum bases. In some embodiments, the chewed cuds from gum bases and chewing gums of the present invention can become brittle and are easily worn away by exposure to foot traffic or other incidental mechanical abrasion. In some embodiments and under some conditions, chewed cuds may be washed away by heavy rainfall.

Polyethylene (also known as polyethene) is a thermoplastic olefin polymer consisting of chains of the monomer ethylene. Polyethylene can be produced in a wide range of molecular weights. For purposes of the present invention, linear polyethylenes having low molecular weight are preferred, although branched polyethylenes are also contemplated for use. By low molecular weight, it is meant that the polyethylene will have a weight average molecular weight (Mw) in the range of 2000 to 23000 daltons as measured by Gel Permeation Chromatography (GPC). In some embodiments, the polyethylene will have a Mw of 4000 to 21000 daltons or 5000 to 18000 daltons. Because the apparent molecular weight of polymers can vary significantly with the method of measurement, it is important to specify how the above molecular weights were determined. Molecular weight determination of polyethylene was accomplished using high temperature GPC. A column temperature of 145° C. was needed to assure that the sample stayed in solution. Trichlorobenzene was used as the solvent and mobile phase for the analysis. The separation of polymeric molecules according to their molecular weights was achieved by use of a Jordi DBV Mixed Bed column (500 mm length, 10 mm ID) and a flow rate of 1.2 ml/min. The eluent was monitored with a refractive index detector and the molecular weight was determined relative to polystyrene standards. Of course, other valid methods of measuring the molecular weight of the polyethylene may be used, but the results may need to be adjusted to make them comparable to the above method.

Polyethylenes useful in the present invention may be obtained from a number of suppliers. One polyethylene which may be used is a powdered linear polyethylene having a weight average molecular weight (measured by GPC) of about 13500 daltons and a polydispersity of about 2.0. Such polyethylene is available from Honeywell International as Honeywell A-C® 9A and from other producers as well.

The gum bases of the present invention may also contain other conventional gum base ingredients such as elastomers, elastomer solvents, plasticizers, plastic resins, emulsifiers, fillers, colors and antioxidants, although not all of these will be present in every case.

In certain embodiments, the gum base further contains a filler, e.g., calcium carbonate, talc, amorphous silica, or combinations of these. While higher levels may be used, some embodiments will comprise from about 0 wt % to about 5 wt % filler, based upon the total weight of the gum base. It has been found that limiting the amount of filler used can enhance removability properties of cuds formed from the base.

Although the present gum bases are expected to exhibit enhanced removability, in some embodiments, the gum bases may further comprise at least one removability enhancing component. The removability enhancing component may comprise an amphiphilic material (such as an amphiphilic polymer), a low tack polymer, a polymer containing hydrolysable units, an ester or ether of a polymer containing hydrolysable units, crosslinked polymeric microparticles or combinations of these. These and other removability enhancing components may be premixed with a chewing gum base or added separately to a chewing gum mixture. In some embodiments an emulsifier, that may be encapsulated or spray dried, may be included in the chewing gum composition as a removability enhancing component.

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not intended to limit what is being described to any one position or spatial orientation.

If ranges are disclosed, the endpoints of all ranges directed to the same component or property are inclusive and independently combinable (e.g., ranges of “up to about 25 wt %, or, more specifically, about 5 wt % to about 20 wt %,” is inclusive of the endpoints and all intermediate values of the ranges of “about 5 wt % to about 25 wt %,” etc.). The modifier “about” used in connection with a quantity is inclusive of the stated value and has the meaning dictated by the context (e.g., includes the degree of error associated with measurement of the particular quantity). Further, unless otherwise stated, percents listed herein are weight percents (wt. %) and are based upon the total weight of the gum base or chewing gum, as the case may be.

In order to further enhance the removability of cuds formed from chewing gums containing the gum bases described herein, it may be desirable to incorporate other known removability-enhancing features into the gum base and/or chewing gum.

For example, certain additives such as emulsifiers and amphiphilic polymers may be added. Another additive which may prove useful is a polymer having a straight or branched chain carbon-carbon polymer backbone and a multiplicity of side chains attached to the backbone as disclosed in WO 06-016179 hereby incorporated by reference herein in its entirety for any and all purposes, to the extent that it is not contradictory to the teachings provided herein. Still another additive which may enhance removability is a polymer containing hydrolyzable units or an ester and/or ether of such a polymer. One such polymer containing hydrolyzable units is a copolymer sold under the tradename Gantrez®. Addition of such polymers at levels of from about 1 wt % to about 20 wt % based upon the total weight of the chewing gum base may reduce adhesion of discarded gum cuds.

Formulating gum bases to contain 5 to 15% of high molecular weight polyisobutylene (for example, polyisobutylene having a weight average or number average molecular weight of 200,000 to 600,000 daltons) may also be effective in enhancing removability.

Within the limits expressed herein, the gum bases made according to this disclosure may be formulated with conventional gum base ingredients at levels normally used for their purpose. Thus, a typical gum base made according to this disclosure may typically contain one or more elastomers, elastomer solvents, softeners, plastic.resins, fillers, colors, antioxidants and emulsifiers as well as other conventional gum base components. That said, there is no specific requirement to use any or all of these components or to use them at conventional levels as long as the resulting gum base is suitable for its purpose.

In some embodiments, gum bases disclosed herein may comprise 3 to 30 wt. %, or 5 to 25 wt. %, or 8 to 20 wt. % of at least one elastomer. Common gum base elastomers include butyl rubber, styrene-butadiene rubber, polyisobutylene, and polyisoprene (for example from natural gums such as chicle, jelutong, lechi caspi perillo. massaranduba balata, massaranduba chocolate, nispero, rosidinha, gutta percha, gutta kataiu, niger gutta, tunu, chilte, chiquibul and gutta hang kang), although other less conventional elastomers may also be employed. One such unconventional elastomer is crosslinked polymeric microparticles as disclosed in co-pending application 61/263462.

In some embodiments, an elastomer solvent may be employed to improve elasticity and compatibility of the elastomer with other gum base components. Elastomer solvents commonly used for synthetic elastomers include but are not limited to, natural rosin esters, often called estergums, such as glycerol esters of partially hydrogenated rosin, glycerol esters of polymerized rosin, glycerol esters of partially or fully dimerized rosin, glycerol esters of rosin, pentaerythritol esters of partially hydrogenated rosin, methyl and partially hydrogenated methyl esters of rosin, pentaerythritol esters of rosin, glycerol esters of wood rosin, glycerol esters of gum rosin; synthetics such as terpene resins derived from alpha-pinene, beta-pinene, and/or d-limonene; and any suitable combinations of the foregoing. The preferred elastomer solvents also will vary depending on the specific application, and on the type of elastomer which is used. Estergums are also a component of natural gums which, when used, typically do not require added elastomer solvent or at least require lower amounts. Where used, it may be desirable to limit elastomer solvent levels to the range of 1 to 32 wt. % of the gum base. Such lower levels may reduce adhesion of chewed cuds to environmental surfaces. Proper usage level will typically depend on the type and level of elastomer present as well as the desired chewing properties of the chewing gum product.

Softeners (including emulsifiers) may be added to gum bases in order to optimize the chewability and mouth feel of a chewing gum based upon the same. Softeners/emulsifiers that typically are used include tallow, hydrogenated tallow, hydrogenated and partially hydrogenated vegetable oils, cocoa butter, mono- and di-glycerides such as glycerol monostearate, glycerol triacetate, lecithin, microcrystalline wax, paraffin, natural waxes and combinations thereof. Lecithin and mono- and di-glycerides also function as emulsifiers to improve compatibility of the various gum base components.

The gum bases of the present invention may optionally include plastic resins. These include polyvinyl acetate, vinyl acetate-vinyl laurate copolymer having vinyl laurate content of about 5 to about 50 percent by weight of the copolymer, and combinations thereof. Preferred weight average molecular weights (by GPC) for polyvinyl acetate are 2,000 to 90,000 or 10,000 to 65,000 (with higher molecular weight polyvinyl acetates typically used in bubble gum bases). For vinyl acetate-vinyl laurate, vinyl laurate content of from about 10 wt % to about 45 wt % of the copolymer is preferred. Where used, plastic resins may constitute 1 to 40 wt. % or 5 to 30 wt. % of the gum base composition.

Fillers typically are inorganic, water-insoluble powders such as magnesium and calcium carbonate, ground limestone, silicate types such as magnesium and aluminum silicate, clay, alumina, talc, titanium oxide, mono-, di- and tri-calcium phosphate and calcium sulfate. Insoluble organic fillers including cellulose polymers such as wood as well as combinations of any of these also may be used. If used, inorganic fillers may typically be included in amounts from about 4 wt % to about 50 wt % filler, based upon the total weight of the gum base. However, because it has been found that high filler levels can increase the adhesion of gum cuds to environmental surfaces, it is preferred that the filler level not exceed 5 wt. % of the gum base.

Colorants and whiteners may include FD&C-type dyes and lakes, fruit and vegetable extracts, titanium dioxide, and combinations thereof. Antioxidants such as BHA, BHT, tocopherols, propyl gallate and other food acceptable antioxidants may be employed to prevent oxidation of fats, oils and elastomers in the gum base.

The gum base described herein may include wax or be wax-free. An example of a wax-free gum base is disclosed in U.S. Pat. No. 5,286,500, the disclosure of which is incorporated herein by reference to the extent that it is consistent with the teachings provided herein. It is preferred that the gum bases of the present invention be free of paraffin wax. If paraffin is to be used, it is preferred that its use be limited to 8 wt. % or less of the gum base.

Chewing gum bases of the present invention may be formulated to have good or even excellent chewing properties. By good or excellent chewing properties, it is meant that the cud will be enjoyable for consumers to chew because it is neither excessively soft nor excessively cohesive, neither excessively bouncy nor dead, not noisy or squeaky and smooth without being excessively slippery. Of course, personal preference of individual consumers will vary in regard to these properties. Formulators of ordinary skill in the art will be able to formulate gum bases within the limitations of the present invention which will satisfy the target consumer. As is always the case, the optimum formulation will be obtained by making first larger, then smaller adjustments to the formula while sensorically evaluating the effect. Rheological measurements can also be of assistance to the formulator. A typical gum base formulated according to the present disclosure may desirably have a shear modulus (the measure of the resistance to the deformation) of from about 1 kPa (10000 dyne/cm²) to about 600 kPa (6×10⁶ dyne/cm²) at 40° C. (measured on a Rheometric Dynamic Analyzer with dynamic temperature steps, 0-100° C. at 3° C./min; parallel plate; 0.5% strain; 10 rad/s). A preferred gum base according to some embodiments of the present invention may have a shear modulus of from about 5 kPa (50000 dyne/cm²) to about 300 kPa (3×10⁶ dyne/cm²), or even from about 10 kPa (1×10⁵ dyne/cm²) to about 70 kPa (7×10⁵ dyne/cm²). However, in some cases it may be desirable to formulate bases falling outside these rheological ranges.

The disclosed gum bases can be produced using conventional mixing techniques. In such processes, the elastomers are typically first ground or shredded along with at least a portion of any desired filler. Then the ground elastomer is transferred to a batch mixer for compounding. Any standard, commercially available mixer (e.g., a Sigma blade mixer) may be used for this purpose. Compounding typically involves combining the ground elastomer with filler and elastomer solvent and mixing until a homogeneous mixture is produced, typically for about 30 to about 70 minutes. Thereafter, any desired additional filler and elastomer solvent are added followed by softeners, while mixing to homogeneity after each addition. Minor ingredients such as antioxidants and color may be added at any time in the process. While it may be possible to add a minor portion (i.e. less than 50%) of the low molecular weight polyethylene during the compounding process, it is preferred that most or all of the low molecular weight polyethylene be added to the base mixer at any time after the compounding step is completed.

Continuous processes using mixing extruders, which are generally known in the art, may also be used to prepare the gum base. In a typical continuous mixing process, initial ingredients including ground elastomer are metered continuously into extruder ports at various points along the length of the extruder corresponding to the batch processing sequence.

After the initial ingredients have mixed homogeneously and have been sufficiently compounded, the balance of the base ingredients are metered into ports or injected at various points along the length of the extruder. Typically, any remainder of elastomer component or other components are added after the initial compounding stage. The composition is then further processed to produce a homogeneous mass before discharging from the extruder outlet. Typically, the transit time through the extruder will be less than an hour.

Exemplary methods of continuous mixing include the following, the entire contents of each being incorporated herein by reference to the extent that they do not contradict the teachings herein: (i) U.S. Pat. No. 6,238,710, which describes a method for continuous chewing gum base manufacturing, which entails compounding all ingredients in a single extruder; (ii) U.S. Pat. No. 6,086,925 which discloses the manufacture of chewing gum base by adding a hard elastomer, a filler and a lubricating agent to a continuous mixer; (iii) U.S. Pat. No. 5,419,919 which discloses continuous gum base manufacture using a paddle mixer by selectively feeding different ingredients at different locations on the mixer; and, (iv) U.S. Pat. No. 5,397,580 which discloses continuous gum base manufacture wherein two continuous mixers are arranged in series and the blend from the first continuous mixer is continuously added to the second extruder.

The completed base may be extruded or cast into any desirable shape (e.g., balls, pellets, sheets or slabs) and allowed to cool and solidify. In some cases, it may be preferable to use an underwater pelletization process for this purpose.

In some cases, it may be desirable to add some of the gum base ingredients to the gum mixer during the gum mixing process.

A typical gum base formulated according to the present disclosure may desirably have a shear modulus (the measure of the resistance to the deformation) of from about 1 kPa (10000 dyne/cm²) to about 600 kPa (6×10⁶ dyne/cm²) at 40° C. (measured on a Rheometric Dynamic Analyzer with dynamic temperature steps, 0-100° C. at 3° C./min; parallel plate; 0.5% strain; 10 rad/s). A preferred gum base according to some embodiments of the present invention may have a shear modulus of from about 5 kPa (50000 dyne/cm²) to about 300 kPa (3×10⁶ dyne/cm²), or even from about 10 kPa (1×10⁵ dyne/cm²) to about 70 kPa (7×10⁵ dyne/cm²).

The gum base described herein may constitute from about 0.1 wt % to about 98 wt % by weight of the chewing gum. More typically, the inventive gum base may constitute from about 10 wt % to about 50 wt % of the chewing gum and, in various preferred embodiments, may constitute from about 20 wt % to about 35% by weight of the chewing gum.

Any of the removability enhancing components discussed herein may also be added to the chewing gum, either instead of, or in addition to, any amount thereof added to the gum base. For example, a polymer containing hydrolysable units or an ester or ether of such a polymer may be added to the chewing gum at levels of from about 1 wt % to about 7 wt % based upon the total weight of the chewing gum.

Further, in some embodiments, high levels of emulsifiers such as powdered lecithin may be incorporated into the chewing gum at levels of 3 to 7% by weight of the chewing gum in order to enhance the removability of gum cuds produced therefrom. In such embodiments, it may be advantageous to spray dry or otherwise encapsulate the emulsifier to delay its release.

Any combination of any number of the described approaches may be employed simultaneously to achieve improved removability. Further, and as described above, the described removability enhancing components, or any other components known to those of ordinary skill in the art to be useful for this purpose, may be incorporated into the gum base and/or chewing gum.

In addition to the gum base, chewing gum typically includes a bulk portion which may include bulking agents, high intensity sweeteners, one or more flavoring agents, water-soluble softeners, binders, emulsifiers, colorants, acidulants, antioxidants, and other components that provide attributes desired by consumers of chewing gum. Any or all of these may be included in the present chewing gums.

In some embodiments, one or more bulking agent(s) or bulk sweetener(s) may be provided in chewing gums described herein to provide sweetness, bulk and texture to the chewing gum. Bulking agents may also be selected to allow marketing claims to be used in association with the chewing gums. That is, if it is desirable to promote a chewing gum as low calorie, low calorie bulking agents such as polydextrose may be used, or, if the chewing gum is desirably promoted as containing natural ingredients, natural bulking agents such as isomaltulose, inulin, agave syrup or powder, erythritol, starches and some dextrins may be used. Combinations of any of the above bulking agents may also be used in the present invention.

Typical bulking agents include sugars, sugar alcohols, and combinations thereof. Sugar bulking agents generally include saccharide-containing components commonly known in the chewing gum art, including, but not limited to, sucrose, dextrose, maltose, dextrin, dried invert sugar, fructose, levulose, galactose, corn syrup solids, and the like, alone or in combination. In sugarless gums, sugar alcohols such as sorbitol, maltitol, erythritol, isomalt, mannitol, xylitol and combinations thereof are substituted for sugar bulking agents.

Bulking agents typically constitute from about 5 wt % to about 95 wt % of the total weight of the chewing gum, more typically from about 20 wt % to about 80 wt % and, still more typically, from about 30 wt % to about 70 wt % of the total weight of the chewing gum.

If desired, it is possible to reduce or eliminate the bulking agent to provide a reduced calorie or calorie-free chewing gum. In such embodiments, the microparticles/gum base may comprise up to about 98 wt % of the chewing gum. Or, a low caloric bulking agent can be used. Examples of low caloric bulking agents include, but are not limited to, polydextrose; Raftilose; Raftilin; fructooligosaccharides (NutraFlora®); Palatinose oligosaccharide; Guar Gum Hydrolysate (Sun Fiber®); or indigestible dextrin (Fibersol®). The caloric content of a chewing gum can also be reduced by increasing the relative level of gum base while reducing the level of caloric sweeteners in the product. This can be done with or without an accompanying decrease in piece weight.

For example, in these and other embodiments, high intensity artificial sweeteners can be used alone or in combination with the bulk sweeteners. Preferred sweeteners include, but are not limited to sucralose, aspartame, salts of acesulfame, alitame, neotame, saccharin and its salts, cyclamic acid and its salts, glycyrrhizin, stevia and stevia derivatives such as Rebaudioside A, dihydrochalcones, lo han guo, thaumatin, monellin, etc., or combinations of these. In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coacervation, and fiber extrusion may be used to achieve the desired release characteristics.

Usage level of the artificial sweetener will vary greatly and will depend on such factors as potency of the sweetener, rate of release, desired sweetness of the product, level and type of flavor used and cost considerations. Generally speaking, appropriate levels of artificial sweeteners thus may vary from about 0.02 wt % to about 8 wt %. When carriers used for encapsulation are included, the usage level of the encapsulated sweetener will be proportionately higher.

A variety of natural or artificial flavoring agents, and may be used in any number or combination, if desired. Flavoring agents may include essential oils, natural extracts, synthetic flavors or mixtures thereof including, but not limited to, oils derived from plants and fruits such as citrus oils, fruit essences, peppermint oil, spearmint oil, other mint oils, clove oil, oil of wintergreen, anise and the like.

Artificial flavoring agents and components may also be used. Sensate components which impart a perceived tingling or thermal response while chewing, such as a cooling or heating effect, also may be included. Such components include cyclic and acyclic carboxamides, menthol and menthol derivatives such as menthyl esters of food acceptable acids, and capsaicin among others. Acidulants may be included to impart tartness.

The desired flavoring agent(s) can be used in amounts of from approximately 0.1 wt % to about 15 wt % of the gum, and preferably, from about 0.2 wt % to about 5 wt %.

Water-soluble softeners, which may also be known as water-soluble plasticizers, plasticizing agents, binders or binding agents, generally constitute between approximately 0.5 wt % to about 15 wt % of the chewing gum. Water-soluble softeners may include glycerin, propylene glycol, and combinations thereof.

Syrups or high-solids solutions of .sugars and/or sugar alcohols such as sorbitol solutions, hydrogenated starch hydrolysates (HSH), corn syrup and combinations thereof, may also be used. In the case of sugar gums, corn syrups and other dextrose syrups (which contain dextrose and significant amounts higher saccharides) are most commonly employed. These include syrups of various DE levels including high-maltose syrups and high fructose syrups. In some cases, low-moisture syrups can replace some or all of the bulking agents typically use, in which case usage levels of the syrup may extend up to 50 wt. % or more of the total gum composition. In the case of sugarless products, solutions of sugar alcohols including sorbitol solutions and hydrogenated starch hydrolysate syrups are commonly used.

Also useful are syrups such as those disclosed in U.S. Pat. No. 5,651,936 and U.S. 2004-234648 which are incorporated herein by reference. Such syrups serve to soften the initial chew of the product, reduce crumbliness and brittleness and increase flexibility in stick and tab products. They may also control moisture gain or loss and provide a degree of sweetness depending on the particular syrup employed.

In some embodiments, an active agent such as a drug, a dental health ingredients or dietary supplement can be used in combination with the gums and gum bases of the present invention. In such cases, the active agent may be incorporated into the gum base, the chewing gum or into associated non-gum portions of a finished product such as into a coating or a candy layer. In some cases, the active may be encapsulated to control its release or to protect it from other product ingredients or environmental factors.

The chewing gum formulations provided herein may also comprise one or more other ingredients conventional in the art, such as gum emulsifiers, colorants, acidulants, fillers, antioxidants and the like. Such ingredients may be used in the present chewing gum formulations in amounts and in accordance with procedures well known in the art of chewing gum manufacture.

Chewing gum is generally manufactured by sequentially adding the various chewing gum ingredients, including the gum base, to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks.

In some embodiments, the chewing gum may be prepared according to a batch process. In such a process, the ingredients are mixed by first melting the gum base and adding it to the running mixer. The gum base may alternatively be melted in the mixer. Color and emulsifiers may be added at this time.

A chewing gum softener such as glycerin can be added next along with a portion of the bulking agent. Further portions of the bulking agent may then be added to the mixer. Flavoring agents are typically added with the final portion of the bulking agent. The entire mixing process typically takes from about five to about fifteen minutes, although longer mixing times are sometimes required.

In other embodiments, it may be possible to prepare the gum base and chewing gum in a single high-efficiency extruder as disclosed in U.S. Pat. No. 5,543,160. Chewing gums of the present invention may be prepared by a continuous process including the steps of: a) adding gum base ingredients into a high efficiency continuous mixer; b) mixing the ingredients to produce a homogeneous gum base, c) adding at least one sweetener and at least one flavor into the continuous mixer, and mixing the sweetener and flavor with the remaining ingredients to form a chewing gum product; and d) discharging the mixed chewing gum mass from the single high efficiency continuous mixer. In yet another alternative, a finished gum base may be metered into a continuous extruder along with other gum ingredients to continuously produce a chewing gum composition.

While the low molecular weight polyethylene will normally be incorporated into the gum base, it is may also be added as a powder to the chewing gum mixer. In such cases it may be desirable to maintain the mixer temperature at a level below the melting point of the polyethylene at the time of addition and thereafter to prevent melting of the polyethylene.

The resultant chewing gums may be formed into sticks, tabs, chunks, tapes, coated or uncoated pellets or balls or any other desired form. In some embodiments, the chewing gum formulation may be used as a component of a greater confectionery product, for example as a center in a hard candy such as a lollipop or as one or more layers of a layered confection which also includes non-gum confectionery layers.

Of course, many variations on the basic gum base and chewing gum mixing processes are possible.

### EXAMPLES

The following examples of the invention and comparative formulations illustrate certain aspects and embodiments of the present invention, but do not limit the invention described and claimed. Amounts listed are in weight percent, based upon the total weight of the gum base, or chewing gum, as the case may be.

### Example 1

An inventive gum base was prepared according to the formula in Table 3.

### Comparative Run 2

A comparative gum base known to have low adhesion to environmental surfaces was prepared according to the formula in Table 3 to act as a reduced adhesion control.

### Comparative Run 3

A comparative gum base typical of conventional bases known to have high adhesion to concrete was prepared according to the formula in Table 3 to act as a high adhesion control.

TABLE 1

| | | Comparative | |
|---|---|---|---|
| | | Run 2 | Comparative |
| | | Reduced | Run 3 |
| | Example 1 | Adhesion | Adhesive |
| | Inventive | Control | Control |
| Polyethylene (Honeywell A- | 61.25 | — | — |
| C ® 9A) | | | |
| Butyl Rubber | 6.50 | 10.46 | 8.67 |
| Polyisobutylene | 6.00 | — | 1.60 |
| Talc | 1.31 | 4.10 | 2.00 |
| Calcium Carbonate | — | — | 20.60 |
| Polyvinyl Acetate | — | 23.72 | 23.91 |
| Fully and Partially | 11.92 | 24.26 | 13.53 |
| Hydrogenated Veg. Oil | | | |
| Lecithin | 3.00 | — | 3.23 |
| Terpene Resin | 10.00 | 31.80 | 22.24 |
| Mono- and Di-glycerides | — | 5.61 | 4.16 |
| Antioxidant | 0.02 | 0.05 | 0.06 |
| Total | 100.00 | 100.00 | 100.00 |

### Example 4

An inventive chewing gum was prepared according to the formula in Table 4.

### Comparative 5

An adhesive chewing gum was prepared according to the formula in Table 4.

### Comparative 6

A reduced adhesion chewing gum was prepared according to the formula in Table 4.

TABLE 4

| | | Comparative | |
|---|---|---|---|
| | | Run 5 - | |
| | | Reduced | Comparative Run |
| | Example 4 - | Adhesion | 6 - Adhesive |
| | Inventive | Control | Control |
| Sorbitol | — | 58.60 | 45.49 |
| Erythritol | 54.50 | — | — |
| Gum base of Ex. 1 | 36.00 | — | — |
| Gum base of Ex. 2 | — | 33.67 | — |
| Gum base of Ex. 3 | — | — | 32.33 |
| Calcium Carbonate | — | — | 14.76 |
| Glycerin | 6.00 | 4.08 | 3.92 |
| Free and Spray Dried | 2.35 | 1.99 | 1.91 |
| Peppermint Flavor | | | |
| Encapsulated and | 1.15 | 1.20 | 1.15 |
| Unencapsulated High | | | |
| Intensity Sweeteners | | | |
| Lecithin | — | 0.46 | 0.44 |
| Total | 100.00 | 100.00 | 100.00 |

The chewing gums of Example/Comparative Runs 4, 5 and 6 were formed into pellets and pan coated with maltitol to a coating level of approximately 30.5% by weight of the finished pellet. The weight of the coated pellets was approximately 1.4 grams each.

The coated chewing gums of Example/Comparative Runs 4, 5 and 6 were tested for removability in four geographic locations. Multiple locations were used to provide a variety of autumn weather conditions. In each location, the chewing gums were tested as follows.

Cud preparation: Two coated pellets (approximately 2.8 grams) were chewed for twenty minutes.

Gum cud placement on paver: A coarse texture concrete paver was rinsed with tap water and air dried overnight. The paver was set on flat ground with the flat surface face up. A freshly chewed gum cud was placed in the center of the paver. The cud was immediately covered by a silicone pad. A person weighing 150-200 lbs (68 to 91 kg.) wearing flat-sole shoes stepped on the covered cud for 2 seconds. The silicone pad was then immediately removed.

Gum cud ageing: 14 days at prevailing outdoor conditions.

Removability Testing: A power washer using cold tap water at 1550 PSI was used to wash the cuds from the concrete. The nozzle angle was set at 60 degrees from the ground, and the spray pattern was set to a fan shape covering 3 cm width on ground when the nozzle was held 40 cm from the cud. The cud was washed for up to 1 minute. A photo was taken before and after the removal test, using a one cent coin as a reference mark for photographic analysis. The percentage of residue remaining after pressure washing was estimated from the after photo. If the cud was completely removed during power wash, the removal time was recorded.

The results of the removability test are summarized below in Table 5. The intervals, where provided, represent one standard deviation (N=3).

TABLE 5

| | | Location | | | |
|---|---|---|---|---|---|
| | | Northeast | Southwest | Midwest | Southwest |
| | | UK | UK | US | US |
| Ave. Temp (° C.) | | 15.7 | 15.6 | 24.4 | 28.3 |
| Ave. Humidity (% RH) | | 74 | 59 | 75 | 18 |
| Ex. 4 | Removal | 4.3 +/− 3.3 | 2.5 +/− 2.5 | 10.5 +/− 5.1 | 12.4 +/− 2.6 |
| Inventive | time (s) | | | | |
| | Residue | 0 | 0 | 0.1 +/− 0.3 | 0.4 +/− 0.4 |
| | (%) | | | | |
| Ex. 5 | Removal | 26 +/− 11 | 31 +/− 7 | 60 | 60 |
| Reduced | time (s) | | | | |
| Adhesion | Residue | 1 +/− 0 | 2 +/− 1 | 81 +/− 26 | 93 +/− 13 |
| Control | (%) | | | | |
| Ex. 6 | Removal | 60 | 60 | 60 | 60 |
| Adhesive | time (s) | | | | |
| control | Residue | 63 +/− 10 | 65 +/− 23 | 58 +/− 26 | 98 +/− 2 |
| | (%) | | | | |

As can be seen from the results, higher temperatures and lower humidities increased adhesion of all samples. However, in each case the inventive sample was more removable than the prior art reduced adhesion control which in turn was more removable than the adhesive control. In fact, the inventive composition was the only product which was essentially 100% removable under all tested conditions.

The chewing gums of Example 4 (inventive) and Comparative Run 6 (adhesive conventional formula) were compared in a consumer test. The gum of Comparative Run 6 was generally preferred, although the gum of Example 4 was deemed acceptable. The most significant deficiencies of Example 4 were low flavor and low elasticity. It is believed that these deficiencies can be corrected through optimization of the formula within the scope of the claimed inventions.

All patents, patent applications, provisional applications, and publications referred to or cited herein are incorporated by reference in their entirety to the extent they are not inconsistent with the explicit teachings of this specification. Further, while only certain features of the invention have been illustrated and described herein, many modifications and changes will occur to those skilled in the art. It is, therefore, to be understood that the appended claims are intended to cover all such modifications and changes as fall within the true spirit of the invention.

1-15. (canceled)
